(19) United States
(12) Patent Application Publication
(10) Pub. No.: US 2026/0014603 A1
(43) Pub. Date: Jan. 15, 2026

(54) A DUAL ROLLER FOR COMPRESSING AND/OR PUNCTURING PLASTIC OR METAL ITEMS AND USE OF THE ROLLERS

(71) Applicant: VARIG GROUP APS, SORØ (DK)

(72) Inventors: Harald HAUG, HEGGEDAL (NO); Preben From HANSEN; Gert HØJGAARD, ROSKILDE (DK)

(21) Appl. No.: 18/994,717

(22) PCT Filed: Jul. 6, 2023
(86) PCT No.: PCT/EP2023/068691

§ 371 Date: Jan. 15, 2025

(30) Foreign Application Priority Data
Jul. 19, 2022 (DK) PA202200695

(51) Int. Cl. B09B 3/32; B09B 3/35; B09B 101/10; B09B 101/65; B09B 101/75; B29B 17/00; B30B 3/04

(52) U.S. Cl. CPC B09B 3/32; B09B 3/35; B29B 17/0052; B30B 3/04; B09B 2101/10; B09B 2101/65; B09B 2101/75; B29B 2017/0057

(57) ABSTRACT

A dual roller (1) for compressing and/or puncture plastic or metal items comprising a first roller (3) and a second roller (4) having parallel axes (5a,b) rotatable mounted in a housing (6) and a drive mechanism (7) for rotating the rollers (3,4) synchronously opposite one another. The outer surfaces (28) of each roller (3,4) comprise an assembly of alternating protruding elements (8) extending from the surface (28). Spacers (9) are arranged so the protruding elements (8) of one roller extend radially into the spacers (9) between adjacent protruding elements (8) on the opposite roller in an alternating manner. The protruding elements (8) are longitudinal rails (11) arranged parallel with the axes (5a,b) of the rollers (3,4, attached to the circumferential surface (28) of the rollers (3,4).

The present invention relates to a dual roller for compressing and/or puncturing objects such as plastic or metal items comprising a first roller and a second roller having parallel axes rotatably mounted in a housing,
a drive mechanism for rotating the rollers synchronously opposite one another,
outer surfaces of each roller comprise an assembly of alternating protruding elements extending from the surface, and spacers arranged so the protruding elements of one roller extend radially into the spacers between adjacent protruding elements on the opposite roller in an alternating manner thereby forming a gap between the rollers,
the protruding elements are longitudinal rails arranged parallel with the axes of the rollers and extend substantially throughout the length of the rollers and are attached to the circumferential surface of the rollers by fastening means,
and each rail comprises an upper surface and an opposite lower surface connected to the surface of the rollers.

The invention also relates to use of a dual roller according to the inventive construction for compression or puncturing bottles and cans in can bottle and can deposit recycling systems and use in a reverse vending machine.

In order to handle recycling packages such as bottles and cans it is common to transport the objects on a transport band in a reverse vending machine. This transport band runs from a delivery station—where the customer puts the bottle/can—and to a box where the bottles/canes are selected. The packages are compressed by the reverse vending machine so that they each take up less space than before being compressed.

Typically, the packages are reduced in volume or crushed by running them between two pressing and/or cutting rollers that mesh with each other which presses the two opposite walls of the container against each other.

Sometimes it is convenient to tear the packages apart, and the rollers cut the walls by cutting teeth of the pressing and cutting rollers so that the two adjacent walls of the compressed container hook into each other or they are teared into smaller pieces. However, often the packages are unintended teared apart. When this happens, it is not possible to reuse the material as different material in this way is mixed with each other.

However, when the cutting is wanted it facilitates to let air escape from a container that is typically closed by a closing cap during crushing and to let residual fluid exit from the container.

US 2022/0097332 A discloses a compressor/device for compression of emptied containers. The device includes a container compressing arrangement provided with a first and a second roller, each roller having annular segments provided with specially shaped protruding elements. The device is for compression of plastic bottles as well as metal cans.

The wear of the teeth of the rollers is significant and when worn down it is necessary to replace the rollers. This is quite expensive and time consuming. The apparatus may stand still while the rollers are replaced. Further, the design of the protruding elements can lead to an unintentional tearing of the packaging.

It is therefore desirable with rollers where the entire construction does not have to be replaced when the compression teeth are worn down but only a part of the rollers and where unintended tearing of the packaging is avoided.

KR 20120130872 discloses a press machine for pressing recyclable material. It reduces maintenance costs by enabling the replacement of a damaged pressing blade. It comprises two rollers installed inside a main body. The drive mechanism rotates the two rollers. Protruding and replaceable portions arranged on the rollers are pressing recyclable materials between the rollers.

The present invention seeks generally to improve the construction of dual rollers such that the abovementioned insufficiencies and drawbacks of today's dual rollers are overcome or at least it provides a useful alternative. Prior art has failed to teach a simple and yet reliable and inexpensive construction of dual rollers which in a safe and reliable manner, without substantially increasing the cost of the system, is able to satisfy the abovementioned much desired characteristics of the mentioned dual rollers. Further the dual rollers according to the invention also improves the distribution of attack-force during use of the rollers thereby reducing the risk of fracture of the element working as compression-teeth.

According to the invention, a dual roller is provided, as per the introductory part of this specification, and wherein
side walls are converging towards the upper surface with an angle V and the rollers having an outer cylindrical circumferential surface, and further the upper surface has a width being smaller than the width between neighboring longitudinal rails measured between an edge of the neighboring rails located where the lower surface and the side wall of each of the longitudinal neighboring rails meet each other.

The rollers according to the invention is especially suitable for being used in reverse vending machines and where a number of items such as bottles and cans are to be compressed or punctured in a short period of time. It is possible with the unique construction to control the treatment of the packaging so that there is no accidental tearing of it;

The two rollers rotate in opposite directions of rotation such that the items to be crushed, punctured or compressed is handled between the rotating rollers. The items are supplied from an inlet opening in the housing and discharged downwards from here.

The crushing rails mounted on the surface of the rollers act as crushing teeth and compress the items caught between the rollers in the gap. The rails are so arranged that the rail of one roller do not collide with the rail of the other roller during rotation of the rollers. The gap between the two rollers is arranged to allow the items to pass through in a compressed or in an intended punctured state.

The rails act in this way as crushing teeth and is subject to a great wear. Further depending on the material of the items there is a specific demand to the shape the protruding elements. By forming them as rails instead of separate teeth following advantages are obtained:
The attack-force during use is distributed over the entire length of the rails.
When rails are worn it is only necessary to replace the worn rails and not the whole roller in question.
The items are compressed without being unintended teared apart. Thereby it is easy to reuse the material as it is divided into material fractions.

However, the rails may be provided with interchangeable projections projecting from the upper surface and with different shape—such as pointed teeth—for handling items in different ways:

The width of the spacer measured between the lower surfaces of the neighboring rails is measured as follows: the chord of the roller measured between a point where the side surface and the lower surface of a rail meets each other and the same nearest point of the nearest neighboring rail.

The dual roller comprises two identical rollers whose unique dimensions and mutual distance provide the right throughput in the dual roller. The relatively large and heavy rollers mean that the machine can easily absorb variations in the amount and nature of the items introduced due to the large inertia in the rollers.

The size, geometry and distance between teeth have emerged after countless trials. The chosen solution ensures that both cans and PET bottles can be compressed in the right way.

Cans must be pressed as flat as possible without tearing.

PET bottles (polyethylene bottles), must also be flattened without being torn to pieces and they are punctured, as they otherwise risk being “inflated” again. The dual roller according to the invention minimize cans and PET bottles so that they take up less space for the sake of further transport after collection, and to make the round bottles/cans flat so that they can be better sorted afterwards on various sorting machines, including recycling of the collected deposit cans and bottles. Further the dual roller sees to that the compressed items leave the machine one by one in a compressed/handled state without being pressed together into a cohesive mass.

According to one embodiment, the side walls of the rails are substantially straight and flat or slightly curved.

According to one embodiment the converging angle V between the side walls of the rails m is 20-45°.

The angle and the straight and flat or slightly curved surfaces cause a little friction between the items and the rollers, whereby the largest part of the supplied energy is used for handling the items. The unique design also sees to that the items are not unintended teared apart.

According to one embodiment the upper surface of the rails is a substantially flat surface.

This supports the crushing of the items without risking that the items are unintended teared apart.

According to one embodiment, the fastening means comprise at least one longitudinal protrusion integrated with and placed at the lower surface of the rail and parallel with a longitudinal axis of the rail, and arranged to fit into a longitudinal groove arranged in the surface of the rollers, said longitudinal groove is arranged parallel to the axis of the roller.

The protrusions are placed in each a longitudinal groove. When the rollers rotate in order to handle the items an attack-force occur towards the rails engaging the items. By having the protrusions placed in grooves the attach force is transferred to the grooves and distributed in their full length. Further, the protrusions/grooves see to, that the rails are placed correctly with same distance between them and parallel with each other.

By integrated is to understand that the protrusion and the rail are made in one.

According to one embodiment, the rails each comprise two integrated protrusions arranged parallel with each other and with a distance between said protrusions,
and the rollers comprise two grooves for each rail being attached to the roller said protrusions are arranged to fit into each their groove.

By having two parallel protrusions the stability of the rails is increased during use of the rollers. Further the two protrusions placed in each their groove are able to withstand greater forces than one protrusion/groove. The fastening means may be supplied with a welding of the rails.

According to one embodiment, the grooves are in cross-section shaped rectangularly with parallel groove sidewalls and a substantially flat bottom of the groove,
and the corresponding protrusion comprises two oppositely placed protrusion-sidewalls and a top surface facing towards the bottom of the groove,
said protrusion-sidewalls are substantially parallel with the groove sidewalls, said grooves and corresponding protrusion are congruent with each other.

By constructing the grooves and the protrusions as described an improved transfer of force is obtained. The grooves and the protrusions are complementary to each other. The two side walls of a protrusion is in contact with the two sidewalls of the groove it is placed into.

The length of the protrusion and the groove is the same as the length of the roller which is around 450 mm.

According to one embodiment, the fastening means comprise through holes in the rails running from the upper surface to the lower surface, and that the rollers comprise cavities of substantially the same diameter and placed next to the holes when the rails are placed on the rollers, which holes and the cavities are arranged to receive second/further fastening means such as bolts.

The throughgoing holes in the rails and the cavities in the rollers are threaded holes/cavities. The number of holes/cavities depends of the size/length of the rollers, but typically there is around 6-8 holes/cavities evenly distributed throughout the rails/rollers.

Bolts are screwed in the holes/cavities and attach the rail in question to the roller in question. However, the fastening means may also be threaded fastening means with a top adapted to tear the items apart. Such a top could be a pointed end of the fastening means or a sharp device with a free distance to the top surface of the rail.

Bolting the rails to the rollers may be supplied with equipping the rails with the protrusions as described above.

According to one embodiment, the fastening means comprise a welding of the rails to the surface of the rollers, said welding is placed along the rails in a region between the sidewalls of the rail in question and the surface of the roller in question.

Welding the rails to the surface of the rollers can be the only way of fastening the rails to the roller. This is an inexpensive way of fastening the rails. When a rail is to be exchanged the rail can be milled away and a new one is placed on the surface and fastened hereto by welding.

However, welding may be supplied with bolting means as described above and/or using protrusions fitting into grooves in the rollers.

According to one embodiment, the lower surface of the rails is adapted to be slightly curved in order to follow the curvature of the surface of the roller By forming the surface as described the fastening by welding becomes easier and more stable.

According to one embodiment, the rails are replaceable longitudinal rails and removably attached to the circumferential surface of the rollers.

When bolts and perhaps also protrusions are used for fixing the rails to the rollers the rails may be exchanged by removing the bolts. The protrusions are for fixing the rails in a certain position and transferring the forces. When welding the rails to the roller the rails are removed by simply milling away and then fastening a new one by welding.-By making the rails replaceable it is possible in an easy way to change the function of the rollers depending on the material and size of the items to be handled.

The fastening means may be combined so all three possibilities are used in one or just using the bolts, using the bolts with protrusion or using the welding with or without bolts or protrusions.

According to one embodiment, the drive mechanism comprises a motor fitted with a speed-regulating gear in order to control the speed, said motor is adapted to drive the rollers by a chain- or belt drive.

The rollers require large and adjustable supplied energy in order to rotate and crush the items. Therefor a drive mechanism as described is the most convenient way to deliver the energy and to regulate the supplied energy.

According to one embodiment, the axis of one of the rollers is adjustable by parallel displacement of the axis whereby its distance to the other roller is changed, and whereby the gap between the rollers is adapted to be changed in size.

The gap can be adjusted whereby items of different size and material can be handled. This makes the dual roller extremely flexible. The gap is measured as the distance between the upper surface of that rail being closest to the opposing roller and the bottom of the spacer it extends into. The compression or the size of the items is determined by the gap which is determined by the rails and the distance between the axes of the rollers. If the size of compression or the fragments of items should be changed it is possible to do so by displacing one of the rollers so the gap is reduced or enlarged.

According to one embodiment a bearing of the lower roller is mounted in a spring-actuated slide guide.

The lower roller of the dual roller can move slightly away from the second roller as its bearings are mounted in a spring-actuated slide guide.

This construction ensures that the machine is not damaged or that the damage is limited if, for example, a deposit box or bottle filled with e.g. frozen liquid or other unintentional massive object etc.

According to one embodiment the objects comprise empty or partly full with liquid cans and bottles, medical waste material.

The invention also relates to use of the dual roller as specified in the introduction. Deposit recycling means recycling of materials where consumers pay a deposit.

### BRIEF DESCRIPTION OF THE DRAWINGS

FIG. 1 is a perspective view of a dual roller according to the invention where the drive mechanism is removed.

FIG. 2 is a front view of the dual roller shown in FIG. 2.

FIG. 3 is a perspective view of a first embodiment of a roller according to the invention and where the replaceable protruding elements/rails are removed

FIG. 4 is a front view of the roller shown in FIG. 3.

FIG. 5 is a perspective view of a first embodiment of a protrusion element/rail which is to be fastened to the surface of the roller showed in FIGS. 3 and 4.

FIG. 6 is a front view of the protrusion element/rail shown in FIG. 5.

FIG. 7 is a perspective view of the device shown in FIGS. 1 and 2 and where a drive mechanism is shown.

FIG. 8 is a perspective view of a second embodiment of a roller according to the invention.

FIG. 9 is a front view of the roller shown in FIG. 8.

FIG. 10 is a perspective view of a second embodiment of a protrusion element/rail which is to be fastened to the surface of the roller shown in FIGS. 8 and 9.

FIG. 11 is a front view of the protrusion element/rail shown in FIG. 10.

FIG. 12 is perspective view of the second embodiment of the roller according to the invention with the protrusion elements shown in FIG. 10 attached to the surface.

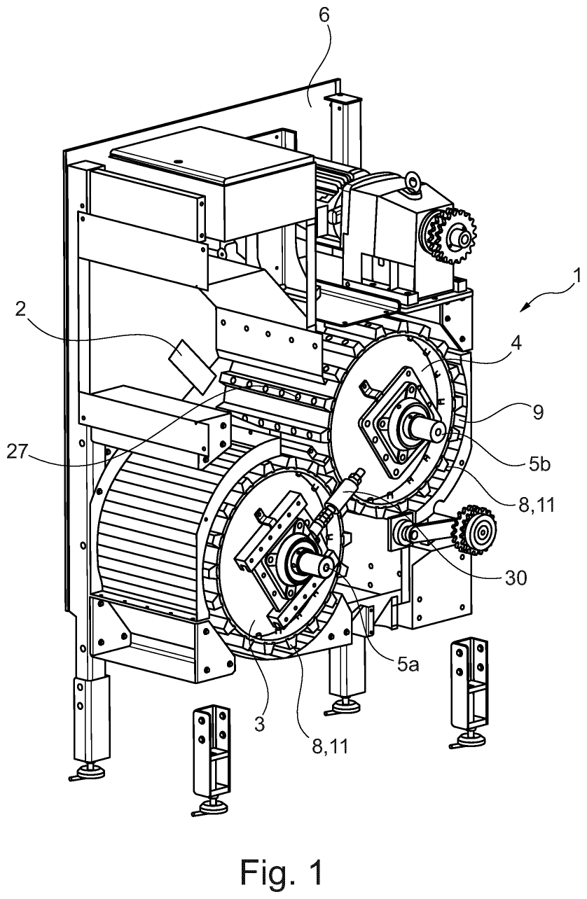

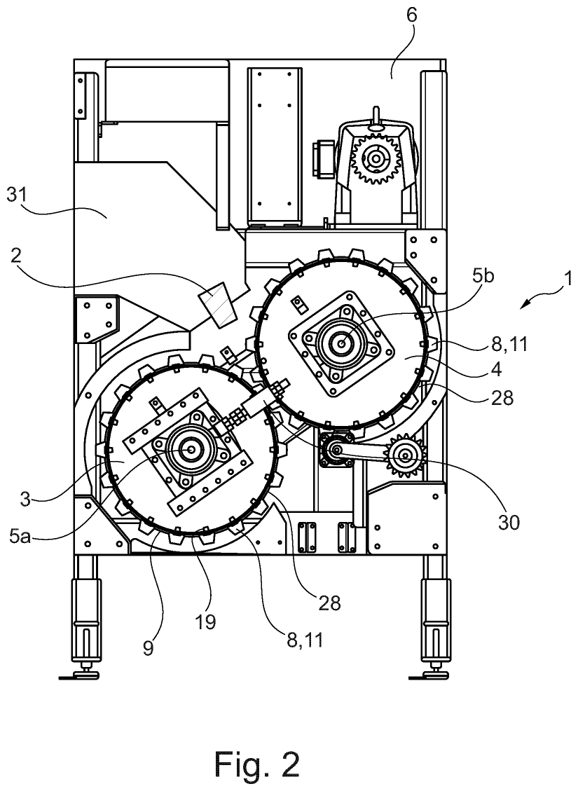

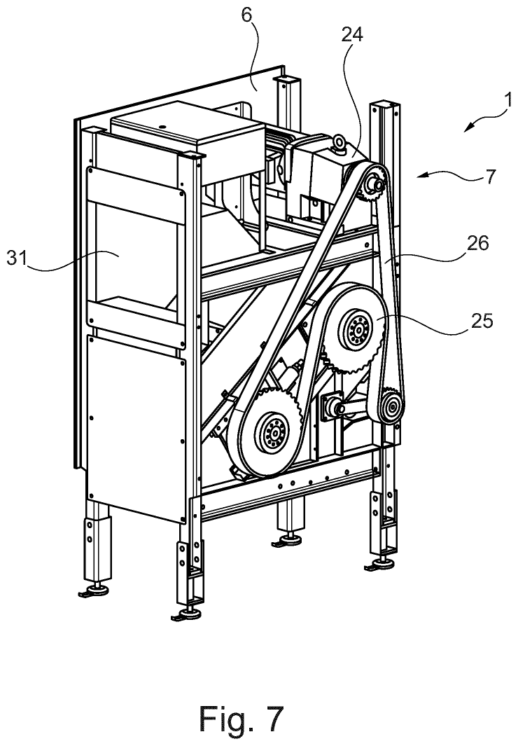

The invention will be explained with reference to FIG. 1, FIG. 2 showing a perspective view and a front view of the dual roller 1 according to the invention. The dual roller 1 is constructed for compressing and/or puncture plastic or metal items 2 such as empty bottles and cans. The dual roller 1 comprise a first roller 3 and a second roller 4 having parallel axis 5a, b. They are rotatable mounted in a housing 6, and have an outer cylindrical circumferential surface 28. The dual roller 1 comprises a drive mechanism 7 which is shown in FIG. 7 for rotating the rollers 3,4 synchronously opposite one another. The drive mechanism 7 comprises a motor 24 fitted with a speed-regulating gear 25 in order to control the speed. The motor 24 is adapted to drive the rollers by a chain- or belt drive 26.

The outer surfaces 28 of each roller comprise an assembly of alternating protruding elements 8 extending from the surface 28 and spacers 9 arranged so the protruding elements 8 of one roller 3 extend radially into the spacers 9 between adjacent protruding elements 8 on the opposite roller 4 in an alternating manner. Thereby a gap is formed between the rollers 3,4. This is where the item 2 such as a plastic bottle is compressed or worn. The items 2 are delivered to the dual roller 1 through an inlet opening 31.

The protruding elements 8 are longitudinal rails 11 arranged parallel with the axes 5a,b of the rollers 3,4. The length of the rails 11 is the same as the length of the rollers 3,4. The rails 11 are evenly distributed over the surface 28 of the rollers 3,4 and removably fastened to the surface 28 of the rollers 3,4 by fastening means comprising devices such as a bolt 27. This is explained below. The fastening may also take place by welding. This is explained with reference to FIG. 12.

The axis 5a,b of one of the rollers 3,4 is adjustable. It is possible to provide a parallel displacement of the axes 5a,b by an adjustment device 30. By activating this the distance between the rollers 3,4 is changed. Thereby the gap between the rollers 3,4 is changed in size. One of the rollers is suspended in a slide bearing and is displaced by a spring action.

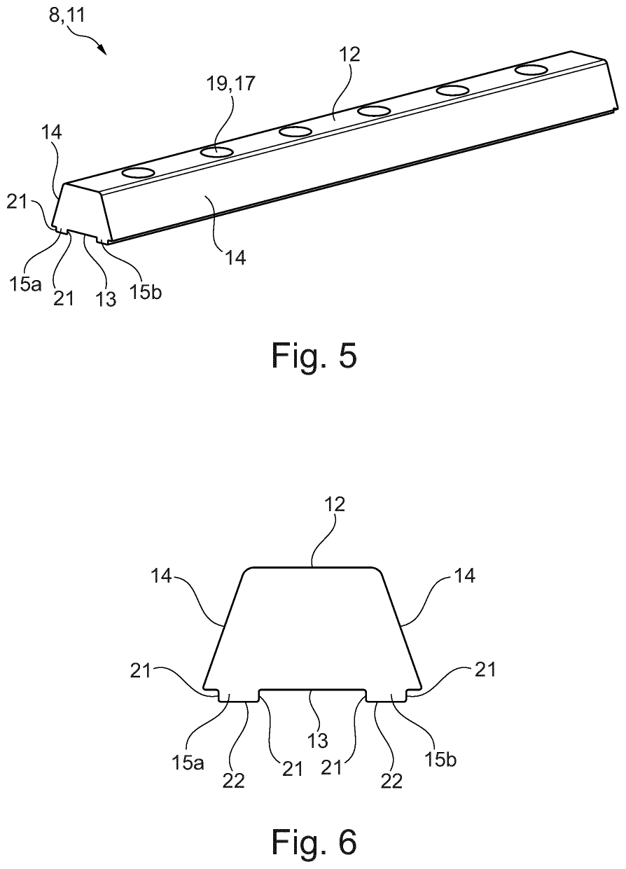

FIGS. 5 and 6 is a perspective and a front view of a rail 11 according to a first embodiment. The fastening means 19 comprise in this embodiment two longitudinal protrusion 15a,b integrated with and placed at the lower surface 13 of the rail 11. They are parallel with the axes of the longitudinal axis of the rail 11, the axes 5a,b of the rollers 3,4 and each other. They are arranged to fit into a longitudinal groove 16 arranged in the surface 28 of the rollers 3,4. The longitudinal grooves 16 are arranged parallel to the axis 5a,b of the rollers 3,4. The rail 11 could also comprise just one protrusion 15.

Each rail 11 comprises an upper surface 12 and an opposite lower surface 13 mounted on and attached removable to the surface 28 of the rollers 3,4. Side walls 14 are converging towards the upper surface 12 with an angle V.

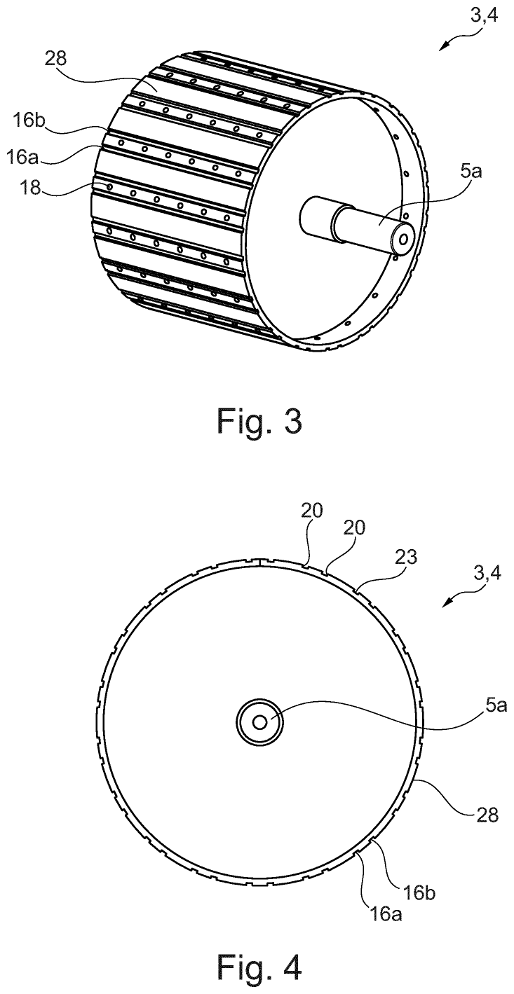

With reference to FIGS. 3 and 4 the first embodiment of the roller 3,4 is shown.

The grooves 16 are in cross-section rectangular grooves 16 with parallel groove sidewalls 20 and a substantially flat bottom 29. The corresponding protrusion 15 shown in FIGS. 5 and 6 comprises two opposite placed protrusion-sidewalls 21 and a top surface 22 facing towards the bottom 29 of the groove 16. The protrusion sidewalls 21 are substantially parallel with the groove sidewalls 20.

The fastening means 19 comprise through holes 17 in the rails 11, cavities in the rollers 3,4 and fastening means such as bolts passing through the holes 17 in the rails 11. These holes are running from the upper surface 12 to the lower surface 13. The rollers 3,4 comprise the cavities 18 of substantially the same diameter and placed next to the holes 17 when the rails 11 are placed on the rollers 3,4. By placing the rails 11 with their protrusions 15a,b in the grooves 16a,b of a roller 3,4, and then fastened them to the rollers 3,4 by the bolts, the rails 11 are replaceable but very safe attached to the roller 11.

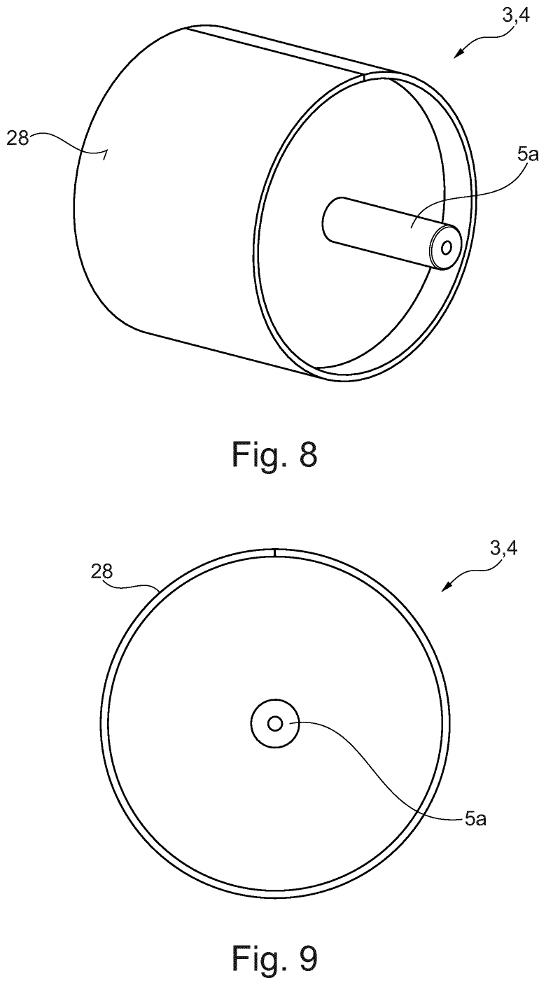

The second embodiment of the invention will be explained with reference to FIG. 8 and FIG. 9 showing a perspective view and a front view of the second embodiment of a roller 3,4 according to the invention. The surface 28 of the roller 3,4 is designed without recesses as is the case with the first embodiment. The surface 28 of the roller 3,4 is smooth.

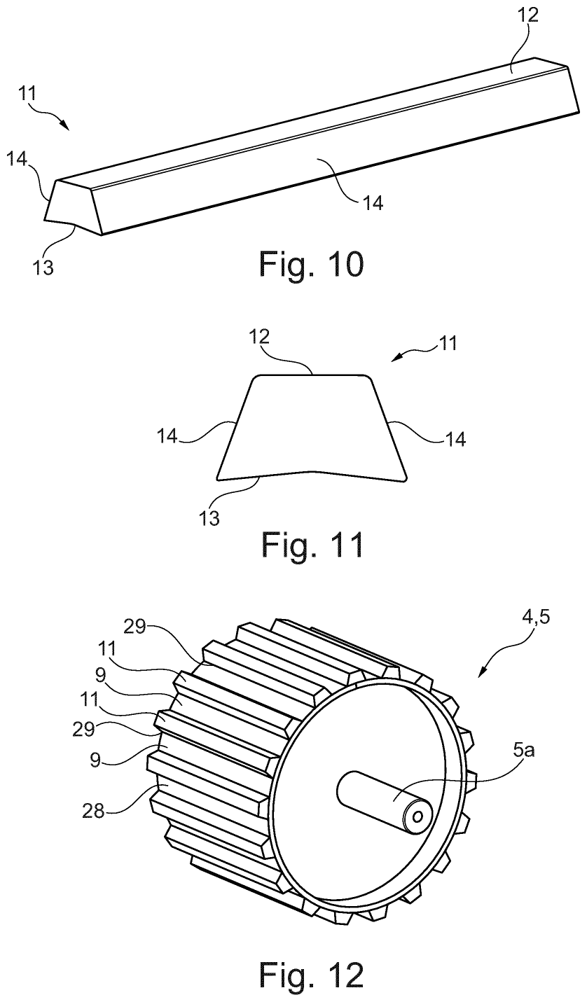

The rail 11 to be fastened to the surface of this embodiment is shown in FIG. 10 and FIG. 11. FIG. 10 is a perspective view of the second embodiment of a protrusion element/rail 11 which is to be fastened to the surface of the roller shown in FIGS. 8 and 9. FIG. 11 is a front view of the protrusion element/rail 11.

The side walls 14 of the rails 11 are substantially straight and flat or slightly curved and the converging angle V between them is 20-45° as is the case with the first embodiment. The upper surface 12 of the rails 11 is a substantially flat surface as is the case with the first embodiment but without through holes for receiving bolts. This is caused by the fact that the rails 11 are fastened to the surface of the roller 4,5 by welding 29. This is shown in FIG. 12. However, the fastening could be combined so the rails 11 are connected to the rollers by bolts and by welding. The rails 11 are placed parallel with the axis 5a of the roller 4,5 in question and with the same distance between them exactly as is the case with the first embodiment.

The welding 29 is placed along the rails 11 in a region between the sidewalls 14 of the rail in question and the surface 28 of the roller 4,5 in question. The lower surface 13 of the rails 11 is slightly curved in order to follow the curvature of the surface 28 of the roller 4,5.

No matter if the first or second embodiment of rails 11 and rollers 4,5 are used for the constructing of a dual roller 1 according to the invention the rails 11 are replaceable longitudinal rails 11 and removable attached to the circumferential surface 28 of the rollers 4,5. When using the dual roller 1, items 2 such as plastic bottles are delivered through the inlet opening 31—see FIGS. 1 and 2—and is compressed by the opposite turning rollers 3,4. The compressed or punctured containers/items fall down and is collected in a box or similar for being transported away. The rails 11 work as crushing teeth known from prior art but the difference between this construction and prior art is that the teeth are not a small tooth-shaped devise but a force-resistant component formed as a rail and running in the whole length of the roller it is attached to. This makes it less sensible to large forces as the compressing force is distributed along the whole length of the rail 11 and transported to the fastening means placed along the whole length of the rail.

The dual roller 1 is especially useful for reverse vending machines as it is very effective and wear resistant. It is able to handle a big number of items in short time and compress or puncture them. The fastening means placed in the holes and cavities may on the top of them have devices suitable for puncturing the items. These devices may also be interchangeable.

When used for crushing the items they are reduced to particle size or granule that can be recycled.

The dual roller according to the invention makes it possible to compress items of different size and made in different material such as steel, copper, aluminum and without the dual roller to get stuck.

Typically, the items 2 are crushed by running them between the two pressing and cutting rollers 3,4 that mesh with each other which press the two opposite walls of the item such as a bottle against each other. Further cuts of the wall of the items is provided when cutting teeth is arranged on the rails.

The cutting also facilitates to let air escape from a container that is typically closed by a closing cap during crushing and to let residual fluid exit from the container.

1-17. (canceled)

18. A dual roller for handling objects such as plastic or metal items comprising:
a first roller and a second roller having parallel axes rotatably mounted in a housing;
a drive mechanism for rotating the rollers synchronously opposite one another;
outer surfaces of each roller comprise an assembly of alternating protruding elements extending from the surface;
spacers arranged so the protruding elements of one roller extend radially into the spacers between adjacent protruding elements on the opposite roller in an alternating manner thereby forming a gap between the rollers;
the protruding elements are longitudinal rails arranged parallel with the axes of the rollers and extend substantially throughout the length of the rollers and are attached to the circumferential surface of the rollers by fastening means;
each rail comprises an upper surface and an opposite lower surface side walls are converging towards the upper surface with an angle V;
the upper surface has a width being smaller than the width between neighboring longitudinal rails measured between an edge of the neighboring rails located where the lower surface and the side wall of each of the longitudinal neighboring rails meet each other;
the rollers comprises an outer cylindrical circumferential surface;
the lower surface of each rail is connected to the outer cylindrical surface of the rollers; and
the compressor is adapted to compress and/or puncture the objects.

19. The dual roller according to claim 18, wherein the side walls of the rails are substantially straight and flat or slightly curved.

20. The dual roller according to claim 18, wherein the angle V between the side walls of the rails is 20-45°.

21. The dual roller according to claim 18, wherein the upper surface of the rails is a substantially flat surface.

22. The dual roller according to claim 18, wherein the fastening means comprise at least one longitudinal protrusion integrated with and placed at the lower surface of the rail and parallel with a longitudinal axis of the rails, and arranged to fit into a longitudinal groove arranged in the surface of the roller, said longitudinal groove is arranged parallel to the axes of the rollers.

23. The dual roller according to claim 22, wherein the rails each comprise two integrated protrusions arranged parallel with each other and with a distance between said protrusions, and the rollers comprises two grooves for each rail being attached to the roller said protrusions are arranged to fit into each their grooves.

24. The dual roller according to claim 22, wherein the grooves are in cross-section shaped rectangularly with parallel groove sidewalls and a substantially flat bottom of the groove, and the corresponding protrusion comprises two oppositely placed protrusion-sidewalls and a top surface facing towards the bottom of the groove, said protrusion-sidewalls are substantially parallel with the groove sidewalls, said grooves and corresponding protrusion are congruent with each other.

25. The dual roller according to claim 18, wherein the fastening means comprise through holes in the rails running from the upper surface to the lower surface, and that the rollers comprise cavities of substantially the same diameter and placed next to the holes when the rails are placed on the rollers, which holes and the cavities are arranged to receive further fastening means such as bolts.

26. The dual roller according to claim 18, wherein the fastening means comprise a welding of the rails to the surface of the roller, said welding is placed along the rails in a region between the sidewalls of the rail in question and the surface of the roller in question.

27. The dual roller according to claim 18, wherein the lower surface of the rails is adapted to be slightly curved in order to follow the curvature of the surface of the roller.

28. The dual roller according to claim 18, wherein the rails are replaceable longitudinal rails and removably attached to the circumferential surface of the rollers.

29. The dual roller according to claim 18, wherein the drive mechanism comprises a motor fitted with a speed-regulating gear in order to control the speed, said motor is adapted to drive the rollers by a chain-or belt drive.

30. The dual roller according to claim 18, wherein the axis of one of the rollers is adjustable by parallel displacement of said axis, whereby its distance to the other roller is changed, and whereby the gap between the rollers is adapted to be changed in size.

31. The dual roller according to claim 18, wherein a bearing of the lower roller is mounted in a spring-actuated slide guide.

32. The dual roller according to claim 18, wherein the objects comprise empty or partly full with liquid cans and bottles, medical waste material.

33. A method of using the dual roller according to claim 18 comprising compressing or puncturing bottles and cans in can bottle and can deposit recycling systems.

34. A method of using the dual roller according to claim 18 in a reverse vending machine.
